(19) United States
(12) Patent Application Publication
(10) Pub. No.: US 2019/0066235 A1
(43) Pub. Date: Feb. 28, 2019

(54) SYSTEMS AND METHODS FOR ENERGY MANAGEMENT

(71) Applicant: Altenex LLC, Boston, MA (US)

(72) Inventors: Robert M. Miller, Reading, MA (US); Brandon D. Bass, Boston, MA (US)

(73) Assignee: Altenex LLC, Boston, MA (US)

(21) Appl. No.: 16/103,774

(22) Filed: Aug. 14, 2018

Related U.S. Application Data
(60) Provisional application No. 62/549,549, filed on Aug. 24, 2017.

(51) Int. Cl. G06Q 50/06; G05B 13/04; G06Q 30/02

(52) U.S. Cl. CPC G06Q 50/06; G06Q 30/0202; G05B 13/048

(57) ABSTRACT

An energy risk management system includes a processing circuit comprising a processor and a memory. The memory is configured to store an energy management application that is executable by the processor to cause the processor to generate a generate a plurality of market scenarios based on a plurality of different sets of market assumptions by adjusting values of a forecast using adjustment data so incorporate an assumption dependency structure into the forecast. The energy management application also causes the processor to generate, for each of the market scenarios, an expected performance value for an energy asset, determine that the expected performance value has a predetermined characteristic for at least one of the market scenarios, and, generate an output. The output may include an alert, an energy asset suggestion, a power production command, and a visualization of a distribution of the generated expected performance value.

### CROSS-REFERENCE TO RELATED PATENT APPLICATIONS

This application claims priority to U.S. Provisional Patent Application No. 62/549,549 filed Aug. 24, 2017, the entire contents of which is incorporated herein in its entirety.

### BACKGROUND

The management of energy costs and production is a complex problem faced by any type of institution. This challenge is especially complex for large institutions, which may hold power productions facilities as well as consume significant amounts of power. To optimize a set of assets from an energy standpoint, however, it is necessary to predict trends in energy prices and consumption. These predictions are exceedingly difficult to accurately make, as various factors outside of one's control such as weather, regulatory change, and technological development may dramatically impact the energy marketplace. These unpredictable variables introduce levels of risk into any energy management strategy. To adequately assist entities in energy management, therefore, it is necessary to understand a range of potential outcomes.

### SUMMARY

One embodiment relates to an energy risk management system. The energy risk management system includes a network interface configured to communicate data over a network, an I/O device configured to communicate data with a user, and a processing circuit comprising a processor and a memory, the memory storing an energy management application, the energy management application being executable by the processor to cause the processor to generate a plurality of market scenarios based on a plurality of different sets of market assumptions. The generating of the plurality of market scenarios includes adjusting values of a forecast using historic data so incorporate an assumption dependency structure into the forecast. The instructions also cause the processor to, for each of the market scenarios, generate an expected performance value for an energy asset. The instructions also cause the processor to determine that the expected performance value has a predetermined characteristic for at least one of the market scenarios, and in response to the determination, generate an output, the output including at least one of: an alert indicative of the predetermined characteristic, an energy asset suggestion, a power production command, and a visualization of a distribution of the generated expected performance value.

Another embodiment relates to a computer-implemented method. The method includes generating, by an energy risk management system, a plurality of market scenarios based on a plurality of different sets of market assumptions, wherein the generating of the plurality of market scenarios includes adjusting values of a forecast using historic data so incorporate an assumption dependency structure into the forecast. The method also includes, for each of the market scenarios, generating, by the energy risk management system, an expected performance value for an energy asset. The method also includes determining by the energy risk management system, that the expected performance value has a predetermined characteristic for at least one of the market scenarios, and in response to the determination, generating, by the energy risk management system, an output, the output including at least one of: an alert indicative of the predetermined characteristic, an energy asset suggestion, a power production command, and a visualization of a distribution of the generated expected performance value.

### BRIEF DESCRIPTIONS OF THE DRAWINGS

FIG. 1 is a block diagram of an environment of an energy management system, according to an example embodiment.

FIG. 2 is a block diagram of the energy management system shown in FIG. 1, according to an example embodiment.

FIG. 3A is a flow diagram of a method of generating a number of market scenarios, according to an example embodiment.

FIG. 3B is a flow diagram of a method of generating an outcome distribution for an energy management strategy, according to an example embodiment.

FIG. 3C is a chart showing example outcome distributions generated via the method shown in FIG. 3B, according to an example embodiment.

FIG. 3D is a flow diagram of a method of identifying a driving market factor for a distribution tail, according to an example embodiment.

FIGS. 3E-3F are charts showing example outcome distributions generated via the method shown in FIG. 3B, according to an example embodiment.

FIG. 4 is a flow diagram of a method of injecting volatility into a simulation of an energy asset, according to an example embodiment.

FIG. 5A is an example graphical user interface enabling a user to set market factor weights for generating an outcome distribution, according to an example embodiment.

FIGS. 5B and 5C are charts showing the results of an energy price simulation, according to various example embodiments.

FIG. 6 is a flow diagram of a method of generating a decomposed performance outlook for an energy asset, according to an example embodiment.

FIG. 7 is a diagram showing an example decomposed performance outlook for an energy asset generated via the method shown in FIG. 6, according to an example embodiment.

FIG. 8 is an example graphical user interface enabling a user to adjust a decomposed performance outlook for an energy asset generated via the method shown in FIG. 6, according to an example embodiment.

FIG. 9 is a block diagram of a power production system, according to an example embodiment.

FIG. 10 is a flow diagram of a method of providing a customized output in response to a simulation indicating a market event, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the figures, systems and methods of implementing an energy management strategy for a user are disclosed. In various embodiments, the systems and methods disclosed herein perform a number of simulations, forecasts, and/or projections based on information regarding a set of energy assets of the user. The results of such simulations, forecasts, and/or projections are used to provide insights of an energy position of the user from multiple different perspectives. For example, in one embodiment, an energy management system generates a number of different market scenarios based on different sets of assumptions regarding various market factors. Such market forecasts include various simulations of market factors at an hourly or sub-hourly time resolution. In some embodiments, at least some of these simulations are adjusted using historic (or synthetic) data to incorporate a dependency structure of market factors into the simulation. To illustrate, hourly price data from a historical year may be used to adjust a simulation of energy price to “inject” the volatility of prices from the historic year into a forecast year of the price forecast. As such, the adjusted forecast reflects the dependency structure of the market factors causing the volatility in the historic year. Beneficially, such a process facilitates the generation of a great number of market scenarios (e.g., over 100,000) incorporating numerous dependency structures amongst various market factors to facilitate assisting a user in formulating an energy strategy.

In another aspect, once the market scenarios have been generated, they are then used to project the performance of a set of energy assets (e.g., an energy production asset such as a wind farm, an energy consumption asset such as a data storage facility) at various points in time into the future. For example, based on the energy utilization of the user, future projected energy prices, and a number of other factors (e.g., demand forecasts, production forecasts, etc.) contained in each generated market scenario, the system may project expected energy costs associated with a first energy asset and the energy revenues associated with a second energy asset at various points in time in the future. The projected cash flows associated with each market scenario may then be combined to present the user with a spectrum of potential outcomes associated with a particular set of energy assets. Furthermore, the system may generate such distributions for various alternative sets of energy assets to enable the user to tailor an energy strategy to conform to the user's risk preferences. As such, the systems and methods employed herein facilitate educating the user regarding long-term risks associated with a particular energy management strategy and facilitate long-term energy planning. For example, based on the projections and visualizations provided herein, a user may choose to adjust the location of a particular energy asset, or alter patterns (e.g., timing) of energy utilization or production.

Conventional financial price forecasts rely purely on assumptions to produce a set of projected values. Because the projected values in typical forecasts are reliant on the assumptions made, it is extremely difficult to account for every factor that may have an impact on energy prices. For example, many current forecasts rely upon the current political party in power to estimate the likelihood of an impactful regulatory reform taking place. Due to the unpredictability of the political sphere, however, such an approach may do more harm to a price projection than good. Additionally, unforeseen sources of risks will consistently introduce volatility into forecasted prices, which assumption-based forecasts will undoubtable fail to take into account. Thus, unlike those provided by the systems and methods herein, typical forecasts fail to provide an adequate outlook as to the full range of potential outcomes of a particular energy management strategy.

Additionally, the approach disclosed herein enables efficient manipulations of already-performed simulations to enable users to view a number of different outcomes associated with various investment strategies. For example, a single set of simulations may be performed for a particular set of assumptions to generate a market scenario. The simulations may then be adjusted using a number of different sets of adjustment data to emphasize different unpredictable price-impacting factors (e.g., weather events, economic downturns, etc.) at various points in time of the simulation. In various embodiments, the adjustment data includes historic hourly or sub-hourly energy pricing data. In some embodiments, the adjustment data includes simulated or estimated future price values (e.g., associated with a fine grain forecast).

As referred to herein, the term “energy asset” relates to any facility, product, object, or other entity that produces or utilizes any amount of quantifiable energy in any form (e.g., electricity, fuel-based, etc.). The term “energy asset” should also be interpreted to include contractual agreements having terms defined based on energy prices, utilization, or production (e.g., an energy swap). As such, the systems and methods disclosed herein are applicable to a broad array of circumstances.

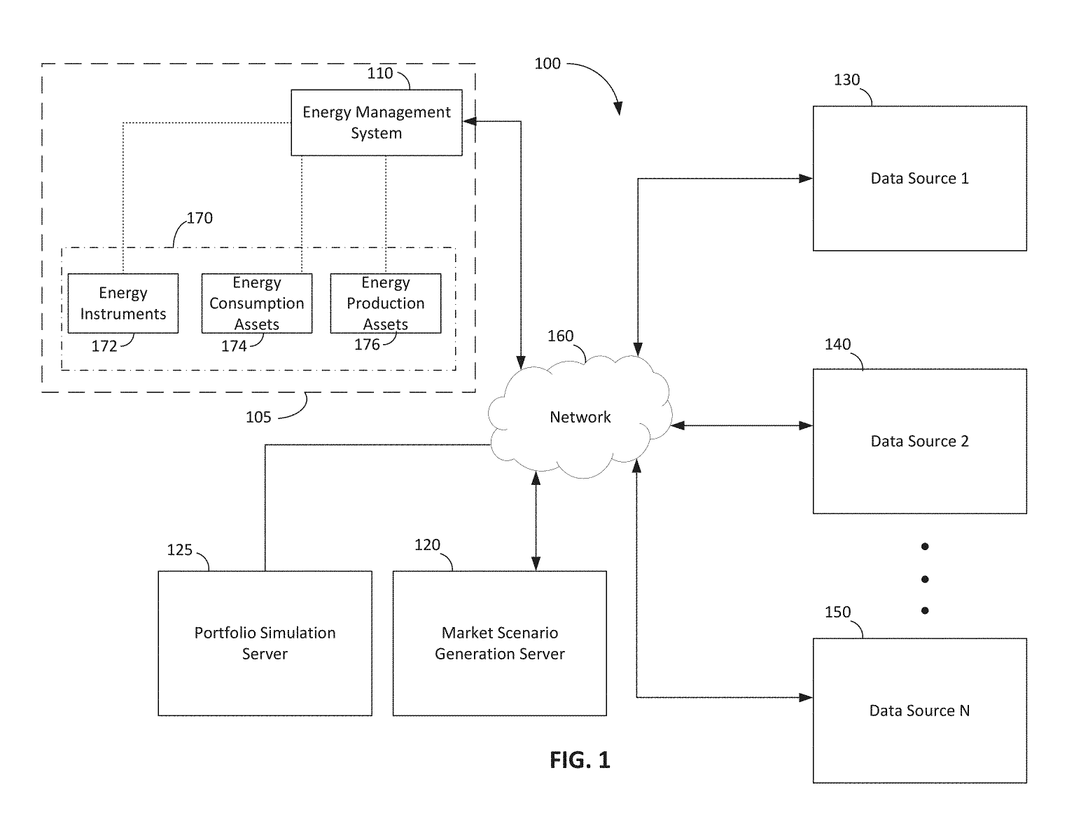

Referring now to FIG. 1, a block diagram of an environment 100 including an energy management system 110 associated with a user 105 is shown, according to an example embodiment. As shown, the environment includes the energy management system 110, a market scenario generation server 120, a portfolio simulation server 125, and data sources 130, 140, . . . , 150. Each of the components within the environment 100 are communicably coupled to one another via a network 160. The network 160 is a data exchange medium, which may include wireless networks (e.g., cellular networks, Bluetooth®, WiFi, Zigbee®), wired networks (e.g., Ethernet, DSL, cable, fiber-based), or a combination thereof. In some arrangements, the network 160 includes the Internet. In some embodiments, the network 160 may further include a proprietary private network to provide secure or substantially secure communications.

User 105 may include any type of entity (e.g., an individual, a corporation, a partnership, a governmental entity, etc.) capable of holding or having any sort of association with an energy asset. As shown, the user 105 owns, operates, or is otherwise associated with a set of energy assets 170. The set of energy assets 170 includes energy production assets 176, energy consumption assets 174, and energy instruments 172. Energy production assets 176 include facilities used in the production of energy that the user may either utilize directly (e.g., to power energy consumption assets 174) or re-sell on an energy market (e.g., the energy produced by the energy production assets 176 may be sold to a wholesale power distributor or utility). Energy production assets 176 may produce energy via any source (e.g., wind, solar, hydroelectric, coal, natural gas, etc.). Energy consumption assets 174, on the other hand, are facilities and/or machinery that consume energy either produced by the user 105 or purchased from an energy market. In various embodiments, the user 105 possesses a number of different energy production assets 176 and/or energy consumption assets 174 at many geographical locations.

Energy instruments 172 include contractual agreements associated with the user 105 tied to energy markets. For example, energy instruments 172 may include commodities futures (e.g., in crude oil), floating swap instruments (e.g., the user 105 may hedge risk pertaining to an energy production asset 176 by agreeing to receive a first price from another party), debt instruments, and/or equity instruments.

The energy management system 110 is a computing system configured to aid the user 105 in the management of the set of energy assets 170. The energy management system 110 may include any suitable form of computing device. As will be understood, the energy management system 110 may include any number of computing devices. In various embodiments, the energy management system includes a personal computing device (e.g., smart phone, tablet, laptop computer, desktop computer) used by an individual or set of individuals associated with the user 105. In various embodiments, the energy management system 110 may perform and/or provide visualizations of the simulations described herein to facilitate aiding the user in formulating a long-term energy strategy. In another example implementation, the energy management system 110 includes a computing system operatively coupled to an energy production asset 176, and directly controls the power production thereof (e.g., the computing system may control rate of production of a coal generator, solar farm, wind farm, etc.). The energy management system 110 may be used to control a level of power production of an energy production asset 176 or a level of power consumption by an energy consumption asset 174 at various times. Alternatively or additionally, the user 105 may use the energy management system 110 in determining where to locate future energy production assets 176 or identifying an energy instrument 172 to purchase.

In this regard, the energy management system 110 communicates with the portfolio simulation server 125 to generate a number of forecasts of future performance values of the set of energy assets 170. The portfolio simulation server 125 may be of any computer architecture and include any number of computing systems without departing from the scope of the present disclosure. In various embodiments, the portfolio simulation server 125 is configured to receive information regarding the set of energy assets 170 from the user 105 and project the future financial performance of the set of energy assets 170 based on market scenarios generated via the market scenario generation server 120.

As described herein, the market scenario generation server 120 simulates a number of market factors based on various combinations of assumptions. For example, the market scenario generation server 120 may employ a number of statistical simulators configured project the status of energy market factors such as energy production (e.g., the status of the electrical grid, alternative energy production simulations), demand, weather, regulatory reform, fuel prices, and electricity prices based on a combination of market assumptions. Such a process may then be repeated with different sets of assumptions to generate thousands or hundreds of thousands of different market scenarios. Based on the different market scenarios, the portfolio simulation server 125 predicts the future performance of the set of energy assets 170. For example, based on information regarding a particular energy asset (e.g., previous energy utilization or consumption data, geographic location, electrical grid, etc.), the portfolio simulation server 125 may project future cash flows associated the energy asset for each of the market scenarios generated via the market scenario generation server 120.

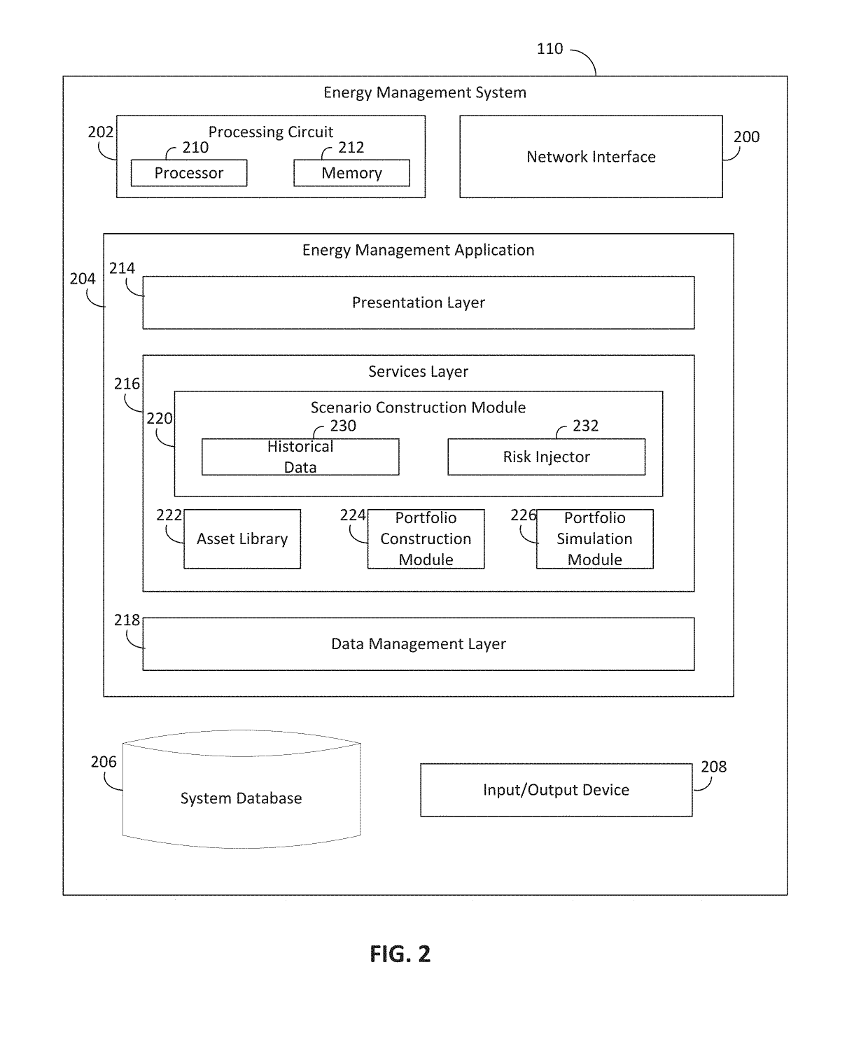

In some embodiments, the portfolio simulation server 125 provides or partly provides an energy management application to the energy management system 110. The energy management application is configured to present visualizations of the simulations performed via the portfolio simulation server 125 and/or the market scenario generation server 120 to the user 105. Additionally, the energy management application includes logic configured to generate other outputs (e.g., market condition alerts, energy utilization commands, energy position alternatives, etc.) based on the performed simulations. The energy management application is described in further detail with respect to FIG. 2 and elsewhere herein.

To perform or otherwise aid in the performance of the simulations described herein, the portfolio simulation server 125 and the market scenario generation server 120 communicate with data sources 130, 140, . . . , 150 to obtain relevant data. For example, a first data source 130 may be associated with a wholesale energy seller (e.g., an electrical grid operator) and provide energy pricing information to the market scenario generation server 120 and/or the energy management system 110. As will be appreciated, the market scenario generation server 120 may receive energy pricing data from any number of similar data sources (e.g., associated with various different geographical locations) consistent with the present disclosure. Second data source 140 may provide forecasts or other forms of information relating to other additional factors having an impact on energy prices (e.g., commodity prices of coal and natural gas, forecasts pertaining to electrical load growth, forecasts pertaining to weather and climate, economic forecasts, renewable energy production capacity predictions, regulatory reform likelihoods, etc.). Data source 150 may provide energy price simulations to the market scenario generation server 120. As such, data source 150 may receive information regarding the set of energy assets 170 from the market scenario generation server 120 and/or energy management system 110 (e.g., existing energy production or consumption information, geographical location, etc.) and project a set of future values of the set of energy assets 170 using any method.

Referring now to FIG. 2, a more detailed view of the energy management system 110 is shown, according to an example embodiment. As shown, the energy management system 110 includes a network interface 200, processing circuit 202, an energy management application 204, a system database 206, and an input/output (“I/O”) device 208. The I/O device 208 includes user interface components as well as software configured to enable an individual to receive and provide data to the energy management system 110. An input device or component of the I/O device 208 allows the user 105 to provide information to the energy management system 110, and may include, for example, a mechanical keyboard, a touchscreen, a microphone, a camera, a fingerprint scanner, any user input device engageable with the energy management via a USB, serial cable, Ethernet cable, and so on. An output device or component of the I/O device 208 allows an individual to receive information from the energy management system 110, and may include, for example, a digital display, a speaker, illuminating icons, LEDs, and so on.

The system database 206 is configured to retrievably store various forms of information pertaining to the set of energy assets 170 of the user 105. Such information may include historical energy production and consumption information, cost and revenue information, weather information, and any other relevant information. In some embodiments, the energy management system 110 includes external data modules for requesting and receiving data from third party systems (e.g., data sources, 130, 140, . . . , 150). The processing circuit 202 and external computing systems (e.g., the portfolio simulation server 125) may retrieve information from the system database may retrieve information from the system database 206 using any known language (e.g., SQL). As described herein, such data may be transformed into a form for analysis via the energy management application 204. As will be understood, the system database 206 may reside within the energy management system 110 or be located elsewhere (e.g., a cloud-based storage facility) without departing from the scope of the present disclosure. Energy management system 110 may include any number of system databases 206 without departing from the scope of the present disclosure.

In addition to the system database 206, the energy management system 110 may store additional forms of data. For example, the energy management system 110 may include visualization data staging module configured to store transient data for access to the visualization tools described herein. Additionally, the energy management system 110 may include a data delivery bus for moving data stored in the system database 206 between services (e.g., provided via the energy management application 204).

As shown, the processing circuit 202 includes a processor 210 and a memory 212. The processor 210 may be a general purpose or specific purpose processor, an application specific integrated circuit (ASIC), one or more field programmable gate arrays (FPGAs), a group of processing components, or other suitable processing components. Processor 210 may be configured to execute computer code or instructions stored in memory 212 or received from other computer readable media (e.g., CDROM, network storage, the simulation server, etc.) to perform one or more of the processes described herein. The memory 212 may include database components (e.g., pertaining to the system database 206), object code components, script components, or any other type of information structure for supporting the various activities and information structures described in the present disclosure. The memory 212 may be communicably connected to the processor 210 via the processing circuit 202 and may include computer code for executing (e.g., by processor 210, etc.) one or more of the processes described herein.

The network interface 200 is configured to facilitate communications with external systems via any established communications protocol (e.g., via the network 160). In various embodiments, the network interface 200 enables such communication via additional modules of the memory 212 (e.g., the energy management application 204) being executed via the processor 210 to facilitate performance of the various processes described herein.

Still referring to FIG. 2, the energy management application 204 is executable by the energy management system 110 (e.g., via the processor 210) to perform various functions described herein. In some embodiments, the energy management application 204 is at least partly a native application on the energy management system 110. In such embodiments, any of the features described herein with reference to the energy management application 204 may be executed via software stored, for example, in the memory 212. In some embodiments, the energy management application 204 is at least partly web-based. In such embodiments, various features described herein with respect to the energy management application 204 may be executed remotely from the energy management system 110 (e.g., at the portfolio simulation server 125).

The energy management application 204 is shown to include a presentation layer 214, a services layer 216, and a data management layer 218. As will be appreciated, such an arrangement is exemplary only. The energy management application 204 may include any number of layers in accordance with any choice of architecture consistent with the present disclosure. Additionally, while each of the layers 214, 216, and 218 are shown to be within the energy management system 110, it should be understood that any of the layers 214, 216, and 218 may reside elsewhere without departing from the scope of the present disclosure. For example, in some embodiments, the energy management application 204 is a web-based application wherein the services layer 216 and/or the data management layer 218 reside at the portfolio simulation server 125, and are provided to the energy management system 110 by a web-based protocol. As such, the level of functionality residing at the energy management system 110 may vary depending on the implementation.

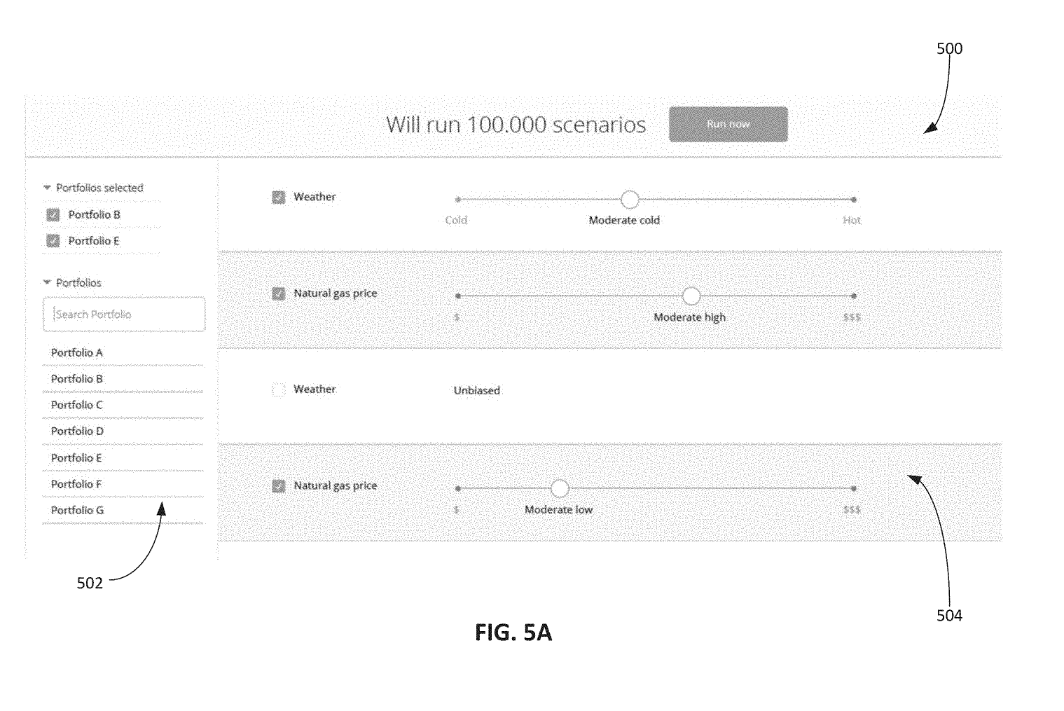

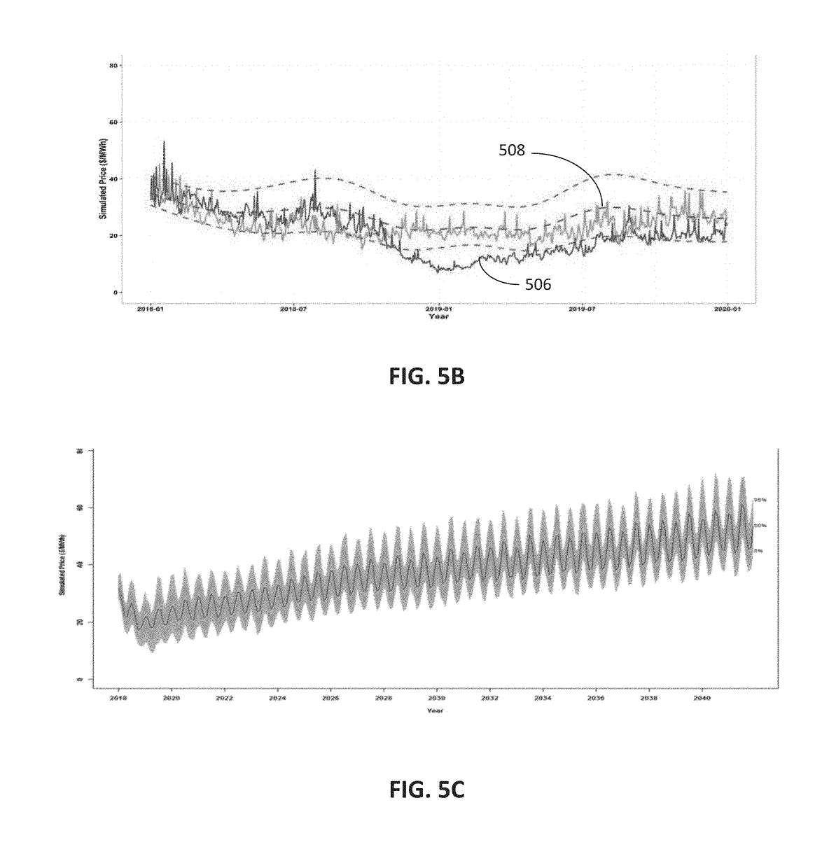

The presentation layer 214 comprises a set of modules that users may directly view or interact with. In various embodiments, the presentation layer 214 is executed via a web browser or the like associated with the energy management system 110. For example, the portfolio simulation server 125 may transmit web content in response to HTTP requests received from the energy management system 110 over the network 160 viewable via the web browser. The web content may present the user 105 with various interfaces enabling the user to provide various inputs to customize the simulations of the set of energy assets 170. An example of such an interface is described below with respect to FIG. 5A. The data management layer 218 includes various modules configured to manage the data stored in the system database 206. For example, data management layer 218 may include a security module configured to restrict access to data stored in the system database 206 to particular users and perform other measures to ensure the security of the stored data (e.g., encryption). Additionally, the data management layer 218 may convert data stored in the system database 206 to short term data stored, for example in a data cache, so the data can be manipulated via the various components of the services layer 216.

The services layer 216 is configured to provide the user 105 with various services to aid the user 105 in the management of the set of energy assets 170. Via various components of the services layer 216, the energy management system 110 constructs numerous potential outcomes (e.g., potential future values) of the set of energy assets 170 across many different potential market scenarios. In this regard, the services layer 216 is shown to include a scenario construction module 220, an asset library 222, a portfolio construction module 224, and a portfolio simulation module 226. It should be understood that the services layer 216 may include more or fewer modules without departing from the scope of the present disclosure.

The scenario construction module 220 is configured to generate a number of market scenarios given various sets of assumptions. In some embodiments, the scenario construction module 220 is at least partly provided to the energy management system 110 via the scenario generation server 120. In various embodiments, any factor that may have any impact on energy price or utilization may serve as an input to the to the scenario construction module 220. As such, inputs provided to the scenario construction module 220 may include, among other factors, macro-economic inputs (e.g., economic forecasts), short or long-term weather forecasts, current energy pricing and demand information, alternative energy production efficiency, political factors, and fossil fuel price projections. In various embodiments, the energy management system 110 receives such input from external data sources 130, 140, . . . , and 150. In some embodiments, inputs used to create a market scenario are selected by the user 105.

In some embodiments, scenario construction module 220 generates a plurality of market scenarios using every possible combination of assumptions amongst a set of assumptions. As an example, if the scenario construction module 220 receives both a set of economic forecasts as well as climate forecasts, a plurality of sets of assumptions may be generated by using every combination of the economic and climate forecasts Such sets of assumptions may be input into a number of simulation modules to forecast for example, levels of energy demand, energy production efficiency, energy production composition (e.g., based on method of energy production), energy production levels, and energy prices at various geographic location across a long time resolution (e.g., 20 years). The forecasts of a particular market scenario may be of an hourly or sub-hourly time resolution. For example, in some embodiments, the scenario construction module 220 utilizes a stochastic structural price model that generates a random field for a particular dependency structure amongst the various market factors, which is used to probabilistically simulate a latent regime process. The results of such probabilistic simulations are then used to generate a set of model inputs, and the resulting model translates the inputs (e.g., the assumptions described above) into a simulated power price.

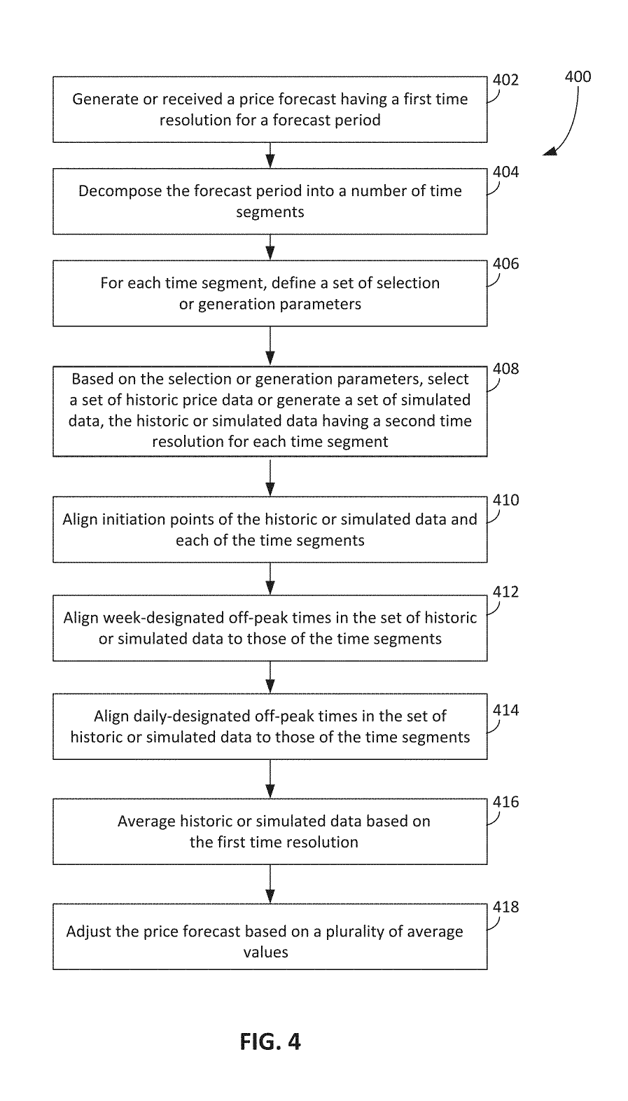

In some embodiments, the forecasts initially generated by the scenario construction module 220 have a course time resolution (e.g., a price forecast may predict a monthly average price into the future) or only take particular factors into account. To generate a finer-grain forecast and/or incorporate pricing fluctuations resulting from additional factors, such as weather, political, and economic inputs, the scenario construction module 220 may utilize sets of historical data 230 and a risk injector 232 to modify the forecasts. The process used by the risk injector 232 to adjust price forecasts is described in further detail with respect to FIG. 4.

As used herein, the term “time resolution” refers to an average interval between independently projected values of a price forecast. For example, a first forecast has one resolution when the forecast generates a plurality of expected values corresponding to hourly price data for a typical week for particular month (e.g., a forecast may provide, in addition to other values, hourly data for a typical week of January five years from now). In another example, a second forecast has another time resolution when the forecast generates a plurality of expected values corresponding to peak/off-peak resolution for a particular month (e.g., a forecast may provide a first value for a particular month for hours corresponding to peak usage hours and a second value corresponding to off-peak usage hours). As such, the term “time resolution” should be interpreted broadly to include any sets of independently projected value spaced apart by any time interval.

In addition to the scenario construction module 220, the services layer 216 also includes an asset library 222 and a portfolio construction module 224. The asset library 222 includes a number of parameters defining particular energy assets that may or may not be held by the user 105. For example, the asset library 222 may include a set of functions representing particular energy consumption assets or production assets meeting various characteristics. In some embodiments, the asset library 222 includes energy assets defined by the user 105. For example, the user 105 may input historic consumption and production data for various energy assets as well as other information (e.g., load profiles, weather data, geographical location) to define a particular asset within the asset library 222. Additionally, the asset library 222 includes a number of potential energy instruments and facilities that are not currently held by the user 105. Thus, by selecting such potential instruments in addition to the instruments already held by the user, the outcome of potential alterations to the set of energy assets 170 may be assessed.

The portfolio construction module 224 is configured to select a set of energy instruments from the asset library 222. In some embodiments, the selection is based on inputs received from the user 105. Alternatively, in some embodiments, the portfolio construction module 224 combines energy asset profiles provided by the user 105 with other energy assets to construct various alternative portfolios having a different composition than the set of energy assets 170 currently held by the user 105. In some embodiments, the portfolio construction module 224 is configured to generate a set of energy assets to simulate responsive to various triggers. In some embodiments, such triggers are changes in market conditions (e.g., as measured in real-time by the energy management system 110). For example, in response to detecting a change in a particular market condition (e.g., fuel price, temperature, electricity price, etc.) that meets pre-defined parameters, the portfolio construction module 224 may retrieve an asset definition from the asset library 222 to generate a new asset portfolio and simulate the performance of the new asset portfolio. In another example, the portfolio construction module 224 may add newly defined assets into the user 105's portfolio. To illustrate, responsive to a new energy technology being introduced into the market, personnel associated with the portfolio simulation server 125 may update the asset library 222 with a new asset definition and, in response, the portfolio construction module 224 may add the new asset definition to the portfolio for simulation.

The portfolio simulation module 226 is configured to simulate various aspects of the performance (e.g., cash flows, power utilization levels, power production levels, etc.) of the portfolio of energy assets constructed by the portfolio construction module 224. For example, based on the electrical grid and geometrical location associated with a particular energy asset, the portfolio simulation module 226 may estimate the future cash flows associated with a particular energy asset. This process may be repeated for each particular energy asset in the portfolio constructed via the portfolio construction module 224. As such, by combining the respective simulated cash flows, the user 105 may be provided with an outlook of individual and combined energy cash flows.

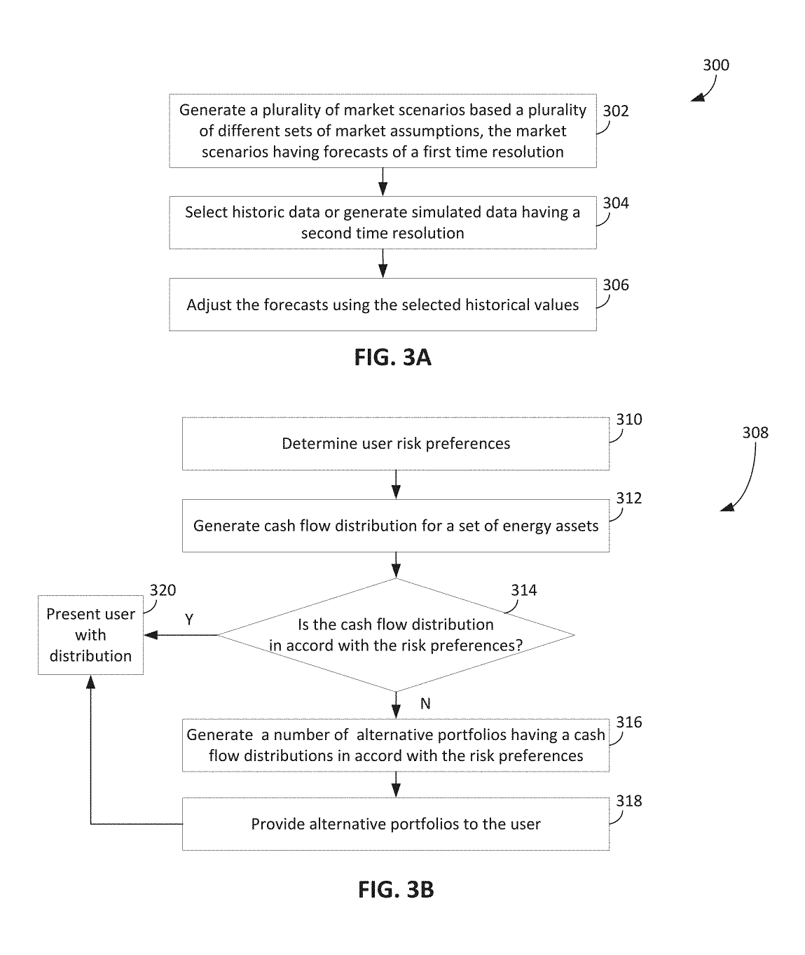

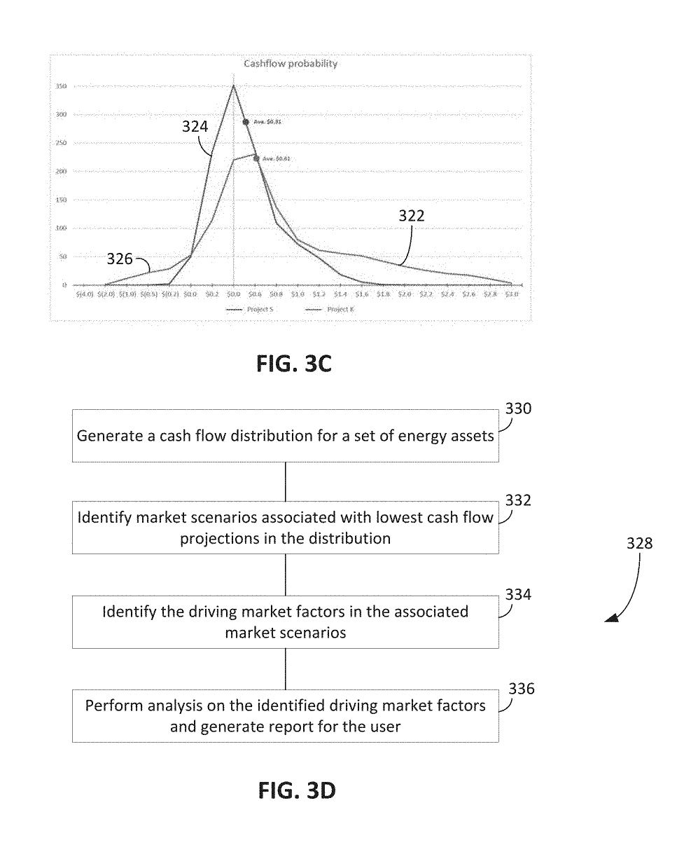

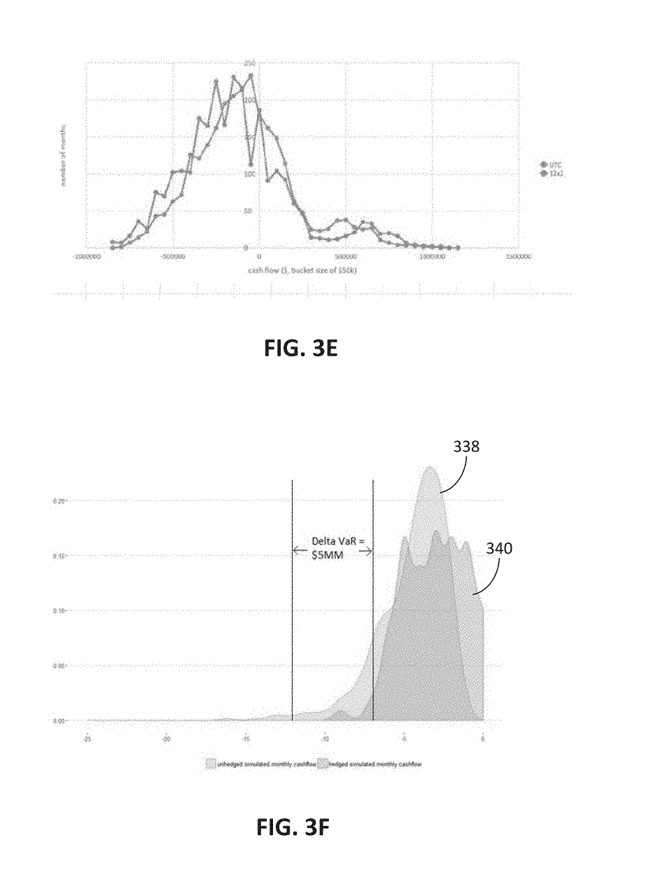

Referring now to FIG. 3A, a flow diagram of a method 300 of generating a plurality of market scenarios is shown, according to an example embodiment. Additional, fewer, or different operations may be performed in method 300 depending on the embodiment. Method 300 may be executed, for example, via the processor 210 of the energy management system 110 (e.g., via the energy management application 204). As will be understood, portions of each of the operations herein described as being performed by the energy management system 110 may be performed via the scenario generation server 120.

At 302, a plurality of market scenarios are generated based on a plurality of different sets of market assumptions. In this regard, the scenario construction module 220 performs simulations based on various sets of assumptions. The set of assumptions may include, for example, a plurality of third party energy price forecasts, economic forecasts, future fuel price estimations, and other predictions and/or assumptions regarding any other market-impacting factor. In one embodiment, the market assumptions define prices ranges of various energy sources (e.g., oil, coal, natural gas, etc.), renewable energy generation, energy transmission buildout, emissions, and/or environmental policy.

After the generation of a plurality of sets of market assumptions, simulations may be performed based on the sets of market assumptions to generate a market scenario. For example, stochastic production cost models utilizing network reduction algorithms may be used to simulate the operational state of the electrical grid. The stochastic production cost model may take into account various factors such as generator dispatch and buildout, transmission buildout, fuel costs, emissions, and environmental policy. The scenario construction module 220 may also employ a demand forecasting and simulation engine to generate possible electricity demand scenarios, as well as a renewable energy production level simulation engine. In addition to these market factors, the scenario construction module 220 may employ the structural price model described herein to simulate overall electricity prices based on the prices of fuel inputs (e.g., coal, natural gas).

At 304, sets of historical data or simulated data are selected and/or generated to adjust forecasts associated with each market scenario. In an example, hourly historic data (e.g., hourly electrical price data) is used to adjust energy price forecasts. As described herein, energy prices may be simulated based on a subset of potential market factors (e.g., fuel source prices). Thus, the projected prices included in such simulation fail to account for the entirety of the risk involved, as other factors (e.g., regulatory change, climatic conditions, economic state, etc.) may have large impacts on energy prices. To account for such additional factors, the scenario construction module 220 may adjust east market scenario simulation with a plurality of sets of historic data to generate a plurality of adjusted scenarios for each set of assumptions. Blocks of historic data of any size and arrangement may be used. For example, the first month of a first historic year may be combined with a second month of a second year to produce a synthetic block of historic data having events desired to be simulated. In some embodiments, rather than using historical data, other (e.g., computationally created) data may be used to adjust the simulations. For example, hourly or sub-hourly forecasts based on different set of assumptions may be generated and used to adjust the courser-grained forecasts contained in the market scenario generated at 302.

In some embodiments, the scenario construction module 220 may select particular sets of historical data to adjust particular market scenario simulations. For example, historical data may be selected based on the set of assumptions used to generate a particular market scenario. For example, in some embodiments, historical data is selected to adjust a particular time interval of a price forecast (e.g., for a particular year in the future) based on trends in a simulation associated with market scenario. To illustrate, if a simulation provides a particular trend in the demand level of fuel (e.g., an increase in percentage from a previous year), historic price data associated with a similar trend in the past may be selected. As such, the scenario construction module 220 may cause the processor 210 to select various sets of historic data to be used to adjust particular time intervals for the generated price forecasts. Such data may be stored, for example, at the system database 206, or the external data sources 130, 140, . . . , 150.

At 306, the price forecasts are adjusted using the selected historic data or generated simulated data. As a result, the adjusted forecasts incorporate various factors (and their associated dependency structure) that impacted energy prices in the past (or in the future, if simulated price data is used), and more accurately reflect the risks associated with real-life energy markets. This provides the user 105 with a more accurate sense of the likely volatility of future energy prices. The process of adjusting the price forecasts will be described in more detail with respect to FIG. 4.

Referring now to FIG. 3B, a flow chart of a method 308 for presenting the customer with a distribution of potential outcomes of an energy management strategy is shown, according to an example embodiment. Additional, fewer, or different operations may be performed in method 308 depending on the embodiment. Method 308 may, for example, be executed by the processor 210 of the energy management system 110 (e.g., via the energy management application 204) to generate a distribution of outcomes for a particular set of energy assets 170.

At 310, customer risk preferences are received. In some embodiments, the user 105 inputs the risk preferences via a graphical user interface provided via the presentation layer 214 of the energy management application 204. To illustrate, the user 105 may define a set risk preferences by providing a target expected value for a set of energy assets 170 at a particular point in time in the future. Additionally, the user 105 may also define a desired characteristic of a distribution (e.g., a desired standard deviation) of potential outcomes. In some embodiments, method 300 may be initiated irrespective of any risk preferences received from the user. For example, the energy management system 110 may initiate execution of the method 300 using a default set of risk preferences.

At 312, a cash flow distribution (or other performance metric distribution) for a set of energy assets is generated. In various embodiments, the energy management system 110 generates these distributions by first generating a plurality of market scenarios via the methods described with respect FIGS. 2 and 3A. In an example, the energy management system 110 (e.g., via the scenario construction module 220) generates over 100,000 market scenarios, with each scenario including hourly or sub-hourly predictions associated with various market factors across a pre-defined time horizon (e.g., 20 years). In some embodiments, these particular market scenarios correspond to particular geographic embodiments. In other embodiments, the market scenarios include a plurality of predicted values for each market factor for any number of geographic locations. These predicted values may be adjusted using sets of historic or synthetic data, as described with respect to FIG. 4.

After generation of the market scenarios, the market scenarios are then used to predict various performance metrics for a set of energy assets. In some embodiments, the set of energy assets is defined by the user 105. For example, the user 105 may input information (e.g., previous energy consumption or production data, billing data, geographic location data, weather data, etc.) regarding a set of energy assets to the energy management system 110, which may then use the user-input information to define a virtualized energy asset. Alternatively or additionally, the energy management system 110 may retrieve pre-defined energy asset definitions from the asset library 222 to construct a synthetic set of energy assets (e.g., via the portfolio construction module 224). The asset definitions may define parameters (e.g., market share, energy production capacities, and/or energy utilization requirements) for the energy asset at various points in time.

After defining a set of energy assets, the parameters of the energy asset definitions are then used in conjunction with the predicted values associated with the simulations of each market scenario to estimate performance metrics (e.g. revenue received, energy costs) for each of the energy assets. As such, each energy asset may have a number of sets of performance estimations associated therewith that corresponds to the number of market scenarios generated via the method 300 discussed above. As an example, an energy production asset 176 may have a plurality of sets of revenue predictions, with each set of revenue predictions corresponding to a particular market scenario. As such, a distribution of expected revenues is generated depending on assumptions regarding different market factors. Similarly, for an energy consumption asset 174, a distribution of expected energy costs may be generated. After such distributions are generated for each energy asset, distributions having corresponding metrics (e.g., dollar amounts) may then be combined to create a distribution of the user 105's overall energy cash flows.

At 314, it is determined if the cash flow distribution is in accord with the risk preferences provided at 302. For example, the expected value of the set of energy assets 170 may be compared with a target level provided by the user 105, and the standard deviation of the potential values may be compared with a desired value. In some embodiments, if the distribution meets the criteria specified by the user 105, the method 308 advances to 320 where the user 105 is presented with a visualization of the distribution. An example of such a visualization is described with respect to FIG. 3C.

If the cash flow distribution does not comport with the user-defined risk preferences, however, an alternative energy asset portfolio is generated at 316. For example, the energy management system 110 may retrieve definitions of multiple additional energy assets from the asset library 222 and add various combinations of the additional energy assets to that defined at 312. In some embodiments, at least some of the additional energy assets are identified based on the set of energy assets 170 defined by the user 105. In an example, the energy management system 110 retrieves a definition associated with an energy instrument 172 that counteracts the risks associated with another energy asset of the user 105 (e.g., a swap instrument).

After a number of alternative sets of energy assets are constructed, the energy management system 110 substantially re-performs 302, 304, and 306 with respect to each of the alternative sets of energy assets to generate additional distributions that may or may not comport to the risk preferences of the user. If not, another energy asset definition may be retrieved from the asset library 222 to further counteract risk associated with the set of energy assets 170 defined by the user. In some implementations, rather than adding to the set of energy assets 170 defined by the user 105, the energy management system 110 amends the set of energy assets (e.g., by suggesting an energy production asset 176 at an alternative location or by removing a particular energy asset).

At 318, alternative energy management strategies are provided to the user 105. For example, each distribution associated with each of the alternative sets of energy assets may be presented to the user 105, and the user may view the definitions associated with the combinations of energy assets associated with each distribution. This way, the user 105 is notified of potential alternatives of achieving a desired risk level in terms of energy management. At 320, the user is presented with a visualization of the various distributions of potential outcomes generated at 316.

Turning now to FIG. 3C, a chart providing example visualizations of distributions generated via execution of the method 308 described with respect to FIG. 3B is shown, according to an example embodiment. As shown, the chart includes a first distribution 322 and a second distribution 324. The first distribution 322 may have been generated based on a set of energy assets 170 defined by the user 105. The second distribution 324 may have been generated based on a set of energy assets including at least one alteration suggested by the energy management system 110. In an example, the second distribution 324 was generated based on simulations performed on the same set of energy assets associated with the first distribution 702, with the exception that the set of energy assets associated with the second distribution 704 includes a hedging instrument (e.g., a swap).

As shown in FIG. 3C, the second distribution 324 has a lower expected value, but also a lower risk associated with it than the first distribution 322. In other words, an outcome within a limited range of the expected value is more likely for the set of assets associated with the second distribution 324. The first distribution 322 includes a tail 326 of lower-cash flow outcomes. As described with respect to FIG. 3D, the energy management system 110 may identify market factors associated with the tail 326. Thus, the systems and methods herein enable the user 105 to efficiently view outcome characteristics with various energy management strategies to select a strategy having desired risk characteristics.

Referring now to FIG. 3D, a flow chart of a method 328 of identifying market factors associated with a tail of an outcome distribution is shown, according to an example embodiment. Method 328 may include additional or fewer operations, depending on the embodiment. Method 328 may be executed, by the processor 210 to identify a set of tail-generating market factors for a user. While described with respect to a distribution tail, it should be understood that the method 328 may be performed to provide the user with indications of the driving factors of any portion of a distribution

Method 328 begins at 330, where distributions are generated for a set of energy assets via performance of the method 308 described with respect to FIG. 3B. Once the distributions are generated, at 332, the market scenarios associated with the lowest (or worst performing) projections in the distribution are identified. For example, in one embodiment, the lowest 10% of projections and associated market scenarios are identified. Upon identification of the market scenarios, the processor 210 may retrieve information regarding the scenarios (e.g., from the system database 206, from the market scenario generation server 120). The information regarding the scenarios may include, for example, the plurality of predicted values associated with the various market factors used to construct the market scenario.

At 334, the driving market factors in the identified market scenarios are identified. For example, the predicted values of the various market factors in the market scenario may be compared with baseline values to determine which market values deviated from normal to drive low performance of the energy asset (e.g. energy prices may have been substantially lower than normal). Having done this for each of the identified scenarios, the system performs an analysis on the identified driving market factors at 336. Certain relationships (e.g., correlations) between each of the market factors may be identified, or the most common driving market factors across the identified scenarios may be identified. At 336, the results of the analysis (e.g., combinations of market factors identified to be most predictive of the lower performance) may then be presented to the user 105 (e.g., a list of the driving factors may be presented to the user). As such, the user 105 is notified of potential causes of future poor performance of a particular energy strategy.

While described with respect to a distribution tail, it should be understood that the method 328 may be performed to provide the user with indications of the driving factors of any portion of a distribution

Referring now to FIG. 3E, a chart showing the results of the various simulations performed via performance of the methods described with respect to FIGS. 3A and 3B is shown, according to an example embodiment. The chart shows the total energy cash flows (e.g., as a result of combining all costs and/or revenues of each energy asset defined by the user 105) on an hourly or sub-hourly basis. Thus, the energy management system 110 provides the users with a detailed outlook for expected energy costs into the future.

Referring now to FIG. 3F, a chart including outcome density distributions for monthly cash flows associated two different sets of energy assets is shown, according to an example embodiment. As shown, the chart includes a first distribution 338 associated with a set of energy assets and a second distribution 340 also associated with the set of energy assets, but also including a hedging energy instrument (e.g., a swap). As shown, the second distribution 340 has a higher downside than the first distribution 338. Thus, the energy management system 110 facilitates the user 105 efficiently comparing potential sets of cash flows to enhance energy decision-making.

Referring now to FIG. 4, a method 400 of using historic data to adjust a price forecast is shown, according to an example embodiment. Additional, fewer, or different operations may be performed in method 400 depending on the embodiment. Method 400 may be executed to inject price variability of a historical time period into a future period to generate a more realistic financial forecast. Method 400 may be executed by, for example, the processor 210 of the energy management system 110 (e.g., via the energy management application 204). As will be appreciated, any of the steps described below may performed remotely from the energy management system 110 without departing from the scope of the present disclosure.

Method 400 begins when a forecast having a first time resolution for a forecast period is either generated or received at 402. In some embodiments, the energy management system 110 generates the forecast via the methods described with respect to FIGS. 2-3 (e.g., based on various market assumptions, demand forecast models, grid performance models, etc.). In some embodiments, the energy management system 110 receives a price forecast, for example generated by the user 105 or by a third party. The price forecast includes a series of projected future prices of, for example, electricity. The forecast may be of any time resolution. For example, one forecast may include a series of month-to-month typical week values over a twenty-five year period. Another forecast may include monthly peak and off-peak prices over a twenty-year period. The forecasts may be generated via any method.

At 404, the forecast period is decomposed into a number of different time segments. In some embodiments, the forecasts are decomposed into one-year periods. As such, forecast for a twenty year period would be deconstructed twenty successive one year segments, with each segment including a number associated projected values. At 406, a set of selection parameters and/or generation parameters are defined for each forecast period. The set of selection parameters are used in the selection of a set of historical data to adjust the projected values associated with a particular year. For example, historic price data associated with a first historic year may be used to adjust a first time segment of a forecast while historic price data associated with a second historic year may be used to adjust a second time segment of the forecast. In various embodiments, the set of selection parameters define various trends in the projected values (e.g., trends in average monthly prices) or the market assumptions that were used to generate the forecast at 402. In some embodiments, a set of generation parameters is used to generate or request a set of estimated or simulated price values having an hourly or sub-hourly time resolution. In some embodiments 406 is omitted from the method 400 and each time segment is adjusted with every single corresponding time segment of historic data or simulation available.

In some embodiments, the set of selection parameters and/or generation parameters are defined based on a desired factor wished to be emphasized in the adjusted forecast. For example, if one desires to introduce volatility into the forecast associated with regulatory reform, a historical year including such an event may be selected. As such, the user 105 may identify timeframes for various events over the forecasted time horizon, and define various selection parameters for each of the time segments to adjust any pre-produced forecast. As such, the systems and methods facilitate adjusting any pre-produced forecast to incorporate risks associated with any combination of events.

At 408, based on the selection or generation parameters, a set of historic price data or simulated price data having a second time resolution is selected for each time segment. For example, based on monthly trends in the projected price values in a particular time segment, a historical year having similar monthly trends may be selected. Alternatively or additionally, particular historical datasets may be selected based on parameters defined by the user 105 for specified time segments. In any event, upon completion of 408, a number of sets of historic data equaling the number of time segments of the forecast are selected. For example, twenty sets of hourly historical electricity price data may be selected for a twenty-year forecast of electricity prices. In some embodiments, 406 and 408 are omitted from the method 400 and each time segment is adjusted with every single corresponding time segment of historic data or simulated available. Furthermore, in some embodiments, synthetic sets of historic data are constructed by combining various sets of historic data (e.g., data associated with a first half of a first year may be combined with data associated with a second half of a second year to generate a synthetic year) used to adjust the forecasts. Alternatively or additionally, rather than selecting a set of historic price data to use in adjusting the forecast, a set of future simulated price values is generated (or retrieved from a third party) and used to adjust the market scenario forecasts. For example, the set of future simulated price values (e.g., having an hourly or sub-hourly time resolution) may have been generated assuming that a particular event (e.g., regulatory reform) would occur at a specific point in time. As such, any combination of fine grain price data, whether it be historic price data or simulation data, may be used to adjust the courser grained forecast data contained in the market scenarios described herein.

At 410, initiation points of the time segments and associated historical or simulation data are aligned. An aim of the method 400 is to inject price variability from a historical instant in time (e.g., on a particular date) to a corresponding time period within a price forecast. In other words, peak energy utilization times in the historical time period should match those of the time segment of the forecast. In an example, where the forecast is broken up into yearly segments, the historic pricing data associated with the first Monday of each historical year is aligned with the first Monday of the forecast year. To do this, an initiation date for the historical period and the forecast time segment is defined. In one example, the initiation date is the Sunday closest to end of the given historical and forecast year (e.g., the initiation date for 2007 would be Dec. 31, 2006). The first Monday is the day after the initiation date. As such, pricing data associated with the Monday of the historic year is used to adjust the Monday of the forecast year.

At 412, week-designated off-peak times in the set of historic or simulation price data are aligned to week-designated off-peak times in the time segments of a forecast period. This operation is to account for off-peak usage times that may occur on different dates each year. Examples include Thanksgiving day, which occur on the fourth Thursday of November. In some examples, the fourth Thursday of November of a particular year will correspond to the first Thursday in December of another year. In embodiments where adjustment occurs month-by-month (as described with respect to 416 and 418), this would result in misaligned adjustment (i.e., the Thanksgiving in one year would not be used to adjust the Thanksgiving in another year). To ensure adequate matching, a check is performed that the dates are aligned to be in the same month (i.e., a November date in the historic year is being used to adjust a November data in the time segment). If the dates are not in the same month, then the first week in December of the historic year may be swapped with the last week in November to ensure matching of the holidays month-by-month.

At 414, daily-designated off-peak times in the set of historical or simulation price data are aligned with those of the time segments. This operation is to account for off-peak days falling on a particular date each year (e.g., Christmas Day, Fourth of July, etc.). If, for example, the historic year has Christmas on a weekend, but the time segment of the forecast has Christmas on a weekday, the adjusted forecast would be missing an off-peak day. To account for such circumstances, the energy management system 110 performs operations that are summarized in accordance with the following table.

TABLE 1

| Historical | | |
|---|---|---|
| Period Daily- | Time Segment | |
| Designated | Daily Designated | |
| Off-Peak Day | Off-Peak Day | Action taken |
| Equivalent | Equivalent | None |
| day of week | day of week | |
| Weekday | Different | Swap weekdays in the historic year |
| | weekday | |
| Weekend day | Different | Swap weekend days in the historic |
| | weekend day | year |
| Weekday | Weekend day | Swap historic year weekday with |
| | | weekend day and duplicate data of |
| | | previous weekday and use in place |
| | | of off-peak weekday in historical |
| | | year |
| Weekend day | Weekday | Swap historical weekend day with |
| | | historical weekday and duplicate |
| | | data of previous weekend day and |
| | | use in place of swapped weekend |
| | | day. |

Thus, as a result of performing operations 414 and 416 off-peak pricing data from historical periods is always used to adjust corresponding off-peak periods in the forecast year to ensure the greatest accuracy in the adjusted forecast.

At 416, the historic or simulated price data is aggregated based on the first time resolution of the price forecast. In an example, if the forecast is monthly peak/off-peak resolution, then aggregates for all of the peak prices for each month of the historical price data are taken. Aggregates for all of the off-peak prices for each month of the historical price are also taken. Statistical measurements of the historic data are then taken (e.g., deviations from the averages at each hour in each month from computed averages, standard deviations, etc.). As such, a measure of the irregularity of energy pricing in the historical data is obtained and used to adjust the price forecast. As described herein, the deviations at a particular point in time (e.g., deviations from average, deltas, a ratio relative to the average, etc.). In another example, if the forecast is a typical hourly week forecast, hourly averages for particular weekdays in each month of historic data may be taken (e.g., hourly prices for all of the Mondays in a particular month are averaged). An example of such a calculation is shown by the table below.

TABLE 2

| | | Difference | Difference |
|---|---|---|---|
| | Historic prices | from average | from average |
| Date | (average is $24.60) | (subtraction) | (ratio) |
| Mon, 1/1/2007 8 am | $20.00 | (−$4.60) | 0.813 |
| Mon, 1/8/2007 8 am | $30.00 | $5.40 | 1.220 |
| Mon, 1/15/2007 8 am | $25.00 | $0.40 | 1.016 |
| Mon, 1/22/2007 8 am | $33.00 | $8.40 | 1.341 |
| Mon, 1/29/2007 8 am | $15.00 | (−9.60) | 0.610 |

At 418, the price forecast is adjusted based on the averaging of the historical price data. In various embodiments, the variability at a particular point in time of the historic data from the average is used to modify the forecasted values provided by the forecast. For the typical hourly week forecast described above, an example set of calculations is described in the following table. In various embodiments, other forms of adjustment may be made.

TABLE 3

| Date | Raw forecast price | Difference-adjusted forecast | Ratio-adjusted forecast |
|---|---|---|---|
| Mon (adj), 12/31/2018 | $22.00 | $17.40 = $22.00 − $4.60 | $17.89 = $22.00 * 0.813 |
| Mon, 1/7/2019 8 am | $27.00 | $32.40 = $27.00 + $5.40 | $32.94 = $27.00 * 1.220 |
| Mon, 1/14/2019 8 am | $27.00 | $27.40 = $27.00 + $0.40 | $27.43 = $27.00 * 1.016 |
| Mon, 1/21/2019 8 am | $27.00 | $35.40 = $27.00 + $8.40 | $36.21 = $27.00 * 1.341 |

As the above example shows, by injecting the variability of the historic price data into the generated price forecast, an adjusted price forecast having a finer granularity is obtained. This provides the user with a more accurate indication as to energy asset performance when the energy is produced or utilized. Additionally, it enables more accurate expected future values of energy assets to be determined, thereby facilitating enhanced energy management strategies. In an example described with respect to FIGS. 3 and 4, the user 105 may use such forecasts in determining a level of power to produce at a particular point in time, or charge higher prices.

Referring now to FIG. 5A, an example graphical user interface 500 is shown, according to an example embodiment. In various embodiments, the graphical user interface 500 is presented to the user 105 via the energy management application 204 (e.g., via the presentation layer 214). As shown, the user interface 500 includes a portfolio selection portion 502 and a weighting selection portion 504. Via the portfolio selection portion 502, the user 105 may select a set of energy assets to be simulated. In some embodiments, the user 105 may input information regarding energy assets owned by the user 105. Additionally, the user 105 may define additional energy assets (e.g., based on the definitions included in the asset library 222) that they wish to include in a portfolio to gain insight into a potential impact that that asset may have on future overall cash flows. Thus, through manipulation of the portfolio selection portion 502 the user may choose any set of energy assets consistent with any set of preferences to perform simulations on.

The weighting selection portion 504 enables the user 105 to weight different market factors differently when performance distributions of sets of energy assets are combined (e.g., during the performance of the method described with respect to FIG. 3B). Upon the user assigning a set of weights, the processor 210 may combine performance distributions in accordance to those weights. This enables the user 105 to view distribution outcomes while weighting factors according to their own preference.

Referring now to FIGS. 5B and 5C, two energy price simulations are shown, according to an example embodiment. FIG. 5B shows a weekly resolution energy price forecast for a particular energy distributor over a three-year time horizon, while FIG. 5C shows a monthly resolution energy price forecast over a twenty-five year period. As shown in FIG. 5B, two weekly price simulations 506 and 508 were performed (e.g., based on a either a different set of market assumptions are a different portfolio). The forecasts (e.g., as a result of the performance of the method 400 described with respect to FIG. 4) display a significant amount of volatility as compared to the other forecasts (indicated by the red dashed lines), thus providing the user 105 with significant insight into the risks associated with a particular energy position. As shown in FIG. 5B, the longer term energy price forecast provides the user 105 with a distribution of potential results.

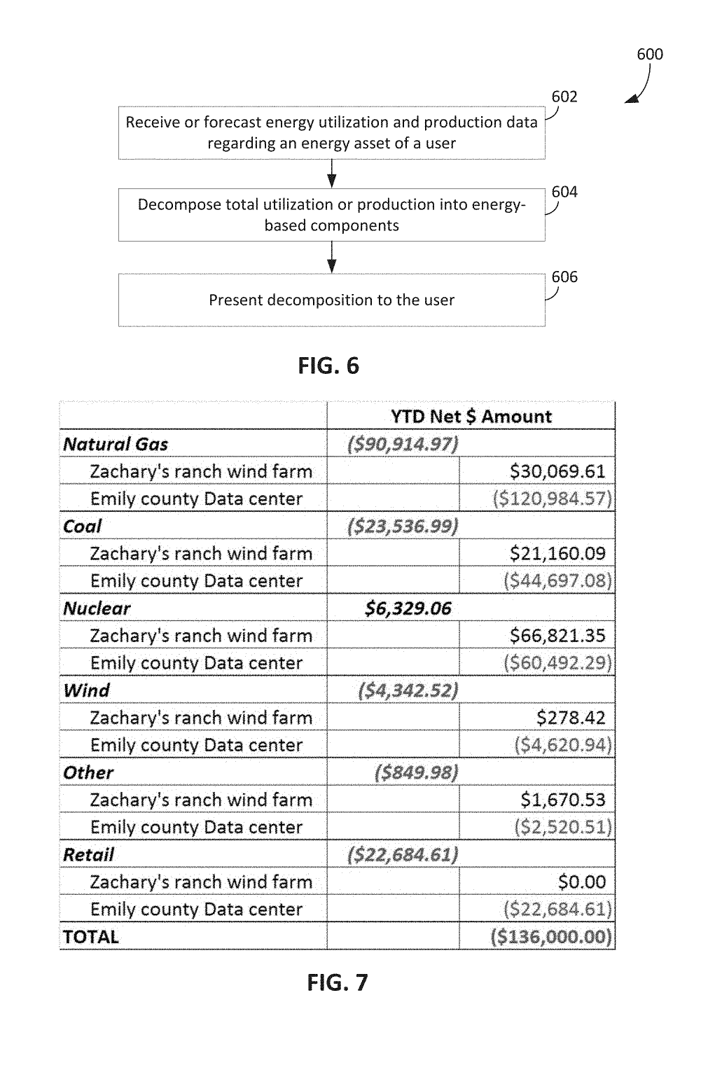

Referring now to FIG. 6, a flow diagram of a method 600 of generating a decomposed outlook for an energy asset is shown, according to an example embodiment. Additional, fewer, or different operations may be performed in method 600 depending on the embodiment. Method 600 may be executed by processor 210 of the energy management system 110 to generate a decomposed energy risk profile. Method 600 begins at 602, where energy utilization and production data regarding an energy asset of the user is received or forecasted (e.g., via performance of the methods described with respect to FIGS. 3A and 3B, the energy management system may forecast future energy production or utilization). For example, the user 105 may input previous energy utilization data associated with an energy consumption asset 174 via an interface presented to the user via the energy management application 204. In another example, the user 105 may input production and revenue data regarding an energy production asset 176.

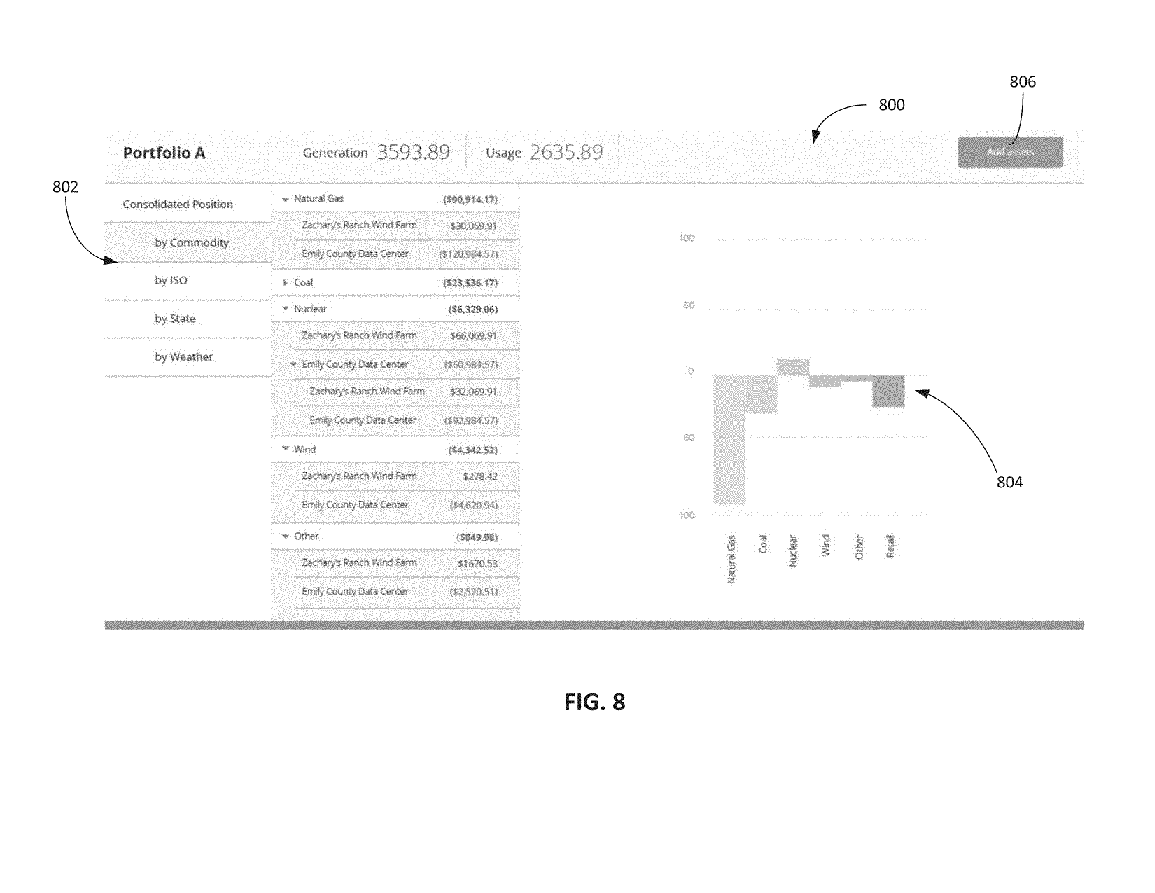

At 604, the revenues, costs and/or other performance metrics associated with the energy asset are decomposed based on a set of energy price components. In an example, costs or revenues associated with an energy asset are broken down by power sources from which energy sold on a wholesale market are derived. To illustrate, for an energy production asset 176, revenues are broken up into source-based components based on the composition of production sources used by a wholesale seller. For example, if the wholesale seller provides energy to the user 105 to operate an energy production asset 176 that is derived from fifty percent natural gas, twenty five percent coal, and twenty five percent nuclear; the revenues may be allocated into source components accordingly. As such, half of the revenues of the user 105 are allocated to a natural gas component, while quarters of the revenues are allocated to coal and nuclear components, respectively. A similar procedure may be followed for an energy consumption asset 174. As such, the user 105 may be notified of the performance of a set of energy assets with respect to each component. An example of such a decomposition is described below with respect to FIGS. 7-8.

It should be understood that any number of energy price components are possible. In another example, costs and/or revenues associated with an energy asset are broken down into generation, distribution, transmission, and taxes and fees (e.g., either associated with an energy distributor or with the user 105). In various other examples, energy costs and revenues may be broken down by time period, weather conditions, by geographic location, or distribution system. As described with respect to FIG. 8, in various embodiments, the user 105 may select from amongst a number a decomposition models to fully understand an energy position.

At 606, the decomposition is presented for the user. For example, in a case where performance metrics associated with multiple energy assets are decomposed at 604, such decompositions may be combined component-by-component to present the user with a visualization of energy asset performance across the various energy component.

Referring now to FIG. 7, an example combined report of decomposed energy cash flows is shown, according to an example embodiment. As shown, the report includes two entries (e.g., columns): one associated with an energy production asset 176 and another associated with an energy consumption asset 174. As shown, historic energy cash flows are decomposed in accordance with compositions of energy used in operating each asset provided by, for example, a wholesale energy seller. The report provides cash flows in each category, in addition to an overall cash flow. This way, the user 105 is able to understand total costs by energy source.

Referring now to FIG. 8, an example graphical user interface 800 is shown, according to an example embodiment. The graphical user interface includes a component selection portion 802, a decomposed results portion 804, and an asset addition button 806. The component selection portion 802 enables the user 105 to select a set of energy price components to decompose energy costs into. As such, upon the user 105 selecting a particular set of energy price components, the performance of the method 600 described with respect to FIG. 6 is altered. For example, upon a user selection of a weather-based set of energy price components, the energy management system 110 may retrieve weather condition data (e.g., from the system database 206), correlate the weather condition data with energy cost data provided by the user 105 (e.g., based on date), and decompose the energy costs based on weather condition. The decomposed results portion 804 includes a graphical depiction of the chart described with respect to FIG. 8, thus providing an immediately comprehensible decomposition. The asset addition button 806 enables the user 105 to add additional energy assets into the performance of the decomposition. For example, the user 105 may manually enter asset data, or select a definition of an asset contained in the asset library 222.

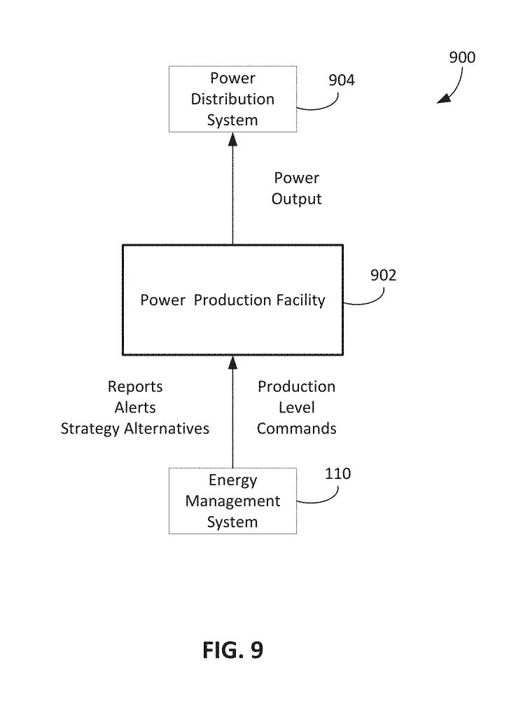

Referring now to FIG. 9, a block diagram of a power production system 900 is shown, according to an example embodiment. As shown, the power production system 900 includes the energy management system 110 described with respect to FIGS. 1-8 herein, a power production facility 902, and power distribution system 904. The power production system 800 is an example use case for the various processes performed by the energy management system 110 described herein. The power production facility 902 may produce power via any method (e.g., coal, natural gas, wind, solar, etc.). In any event, the power production 802 facility produces a variable output of power to the power distribution system 904 (e.g., an electrical grid).

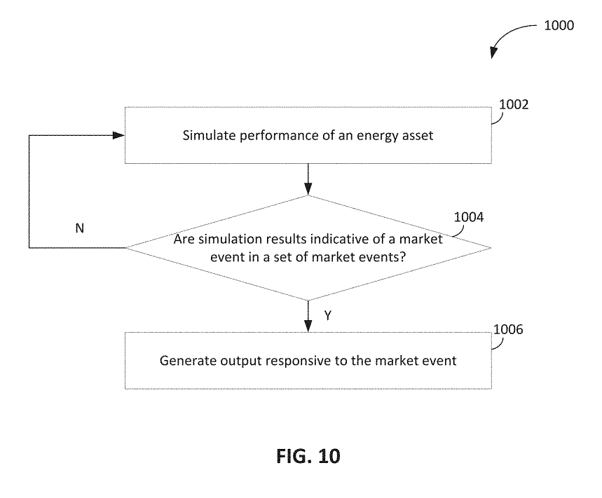

In various embodiments, the energy management system 110 may be used to facilitate making both long-term strategic energy decisions and real-time power production decisions (e.g., either automatically or via power production personnel). As described with respect to FIG. 10, by providing numerous projected outcomes based on market scenarios that are updated frequently, the energy management system 110 may be employed to provide power production level commands, long term market reports, energy management alternatives, and market condition alerts to the power production facility 902.

Referring now to FIG. 10, a flow diagram of a method 1000 of providing a customizable output to a power production facility 902 is shown, according to an example embodiment. Additional, fewer, or different operations may be performed in method 1000 depending on the embodiment. The method 1000 may be executed by, for example, by the energy management system 110, as shown in FIG. 9 to provide alerts or power production commands to an power production facility 902. It should be understood that the energy management system 110 may perform a method similar to the method 1000 for a portfolio of energy assets rather than just the power production facility 902.

At 1002, the method 1000 begins when the energy management system 110 forecasts the performance of an energy asset (e.g., the power production facility 902). In some embodiments, the power production facility 902 provides real-time generation data (e.g., power production levels, sensed load levels, weather conditions etc.) to the energy management system 110. Based on this information as well and a plurality of market scenarios received from, for example, the scenario generation server 120, the energy management system 110 simulates the future performance of the energy asset. For example, the energy management system 110 may generate a plurality of projections of an upcoming revenue stream of the power production facility 902 within a predetermined time frame (e.g., an hour, a day, a week, twenty years, etc.) across a number of different market scenarios to generate a distribution of potential outcomes. In some implementations, the market scenarios are combined with weights provided by the user, as described with respect to FIG. 5A. As described herein, in other implementations, the energy management system 110 may generate a plurality of such projections for a set of energy assets, as described with respect to FIGS. 3-4.

At 1004, it is determined if the simulation results are indicative of a market event. For example, in some embodiment, the user 105 (e.g., the owner of the power production facility 902, an owner of a plurality of energy consumption and production assets 174 and 176) may define a set of market events desired to serve as triggers for a customized output provided by the energy management system. In an example, the user 105 may wish to be alerted if the price volatility within a predetermined period is above a threshold in a certain percentage of simulations performed at 1002. In another example, the user 105 may wish to be alerted if a projected energy price a pre-defined time period from present (e.g., five years) is above or below a threshold level. In yet another example, the user 105 may wish to be alerted if the distribution of performance estimations for the energy asset reaches a predetermined characteristic (e.g., the standard deviation of cash flows is above a threshold level). In various alternative embodiments, the user 105 may be alerted to such occurrences automatically (e.g., without the user defining any conditions). If the simulations results are not indicative of one of the market events, the method 1000 returns to 1002 where another simulation of the energy asset is performed within a predetermined period (e.g., in a week, in a month, etc.).

At 1006, if the simulation results are indicative of at least one of the market events, an output is generated and provided to the user 105. In one example, in response to an electricity price having a volatility level above a threshold, an alert is provided to the user 105. In another example, if the simulation results indicate a relatively low downside in terms of energy asset performance, the energy management system 110 may generate an energy asset suggestion (e.g., as described with respect to FIG. 3B) and provide that to the user 105. The suggestion may provide a suggested power production levels to the user 105, allowing the user to adjust the power production of the power production facility 902. Alternatively or additionally, the suggestion may provide a suggestion that the user purchase an energy instrument 172 that offsets the risks associated with the power production facility 902 (e.g., a swap). In another example, the user 105 may program the energy management system 110 to automatically adjust the power production of the energy production facility 902 or other individual energy asset (e.g., a set of solar panels, etc.) in response to certain market positions being detected. For example, in response to a higher volatility of energy price being detected, the energy management system 110 may automatically adjust the power production downward or upward depending on the risk preferences of the user. As such, the systems and methods disclosed herein are highly customizable depending on user preferences. Any number of visualizations, alerts, reports, and power production level commands may be provided to facilitate assisting the user in long-term energy management strategies.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In some embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. An energy risk management system, comprising:
a network interface configured to communicate data over a network;
an I/O device configured to communicate data with a user;
a processing circuit comprising a processor and a memory, the memory configured to store an energy management application, the energy management application being executable by the processor to cause the processor to:
generate a plurality of market scenarios based on a plurality of different sets of market assumptions, wherein the generating of the plurality of market scenarios includes adjusting values of a forecast using adjustment data so incorporate an assumption dependency structure into the forecast;
for each of the market scenarios, generate an expected performance value for an energy asset;
determine that the expected performance value has a predetermined characteristic for at least one of the market scenarios; and
in response to the determination, generate an output, the output including at least one of: an alert indicative of the predetermined characteristic, an energy asset suggestion, a power production command, and a visualization of a distribution of the generated expected performance value.

2. The energy risk management system of claim 1, wherein the predetermined characteristic is that a range of the generated expected performance values is above a threshold to indicate a high market volatility.

3. The energy risk management system of claim 2, wherein the output includes an alert for display via transmittal via the network interface.

4. The risk management system of claim 1, wherein the predetermined characteristic is that the standard deviation of the generated expected performance values is above a threshold value.

5. The energy risk management system of claim 4, wherein the output includes both the visualization of the distribution and an energy asset suggestion.

6. The energy risk management system of claim 1, wherein the energy asset includes a power generator, wherein the output includes a power utilization command.

7. The energy risk management system of claim 1, wherein the instructions further cause the processor to:
decompose at least one of the generated expected performance values into energy price subcomponents; and
present, via the I/O device, the user with a visualization of the decomposed generated expected performance value.

8. The energy risk management system of claim 7, wherein the instructions further cause the processor to:
receive, via the I/O device, a set of risk preferences associated with the user;
determine that the distribution of expected performance values does not comport with the set of risk preferences;
in response to determining that the distribution of projected values does not comport with the set of risk preferences, identify an energy management alternative, the energy management alternative including a suggested alteration of a set of energy assets belonging to the user.

9. The energy risk management system of claim 1, wherein the historical data is selected based on a desired dependency structure to incorporate into one of the market scenarios.

10. The energy risk management system of claim 9, wherein the historical data includes energy prices from a previous year or a combination of previous years.

11. A computer-implemented method, comprising:
generating, by an energy risk management system, a plurality of market scenarios based on a plurality of different sets of market assumptions, wherein the generating of the plurality of market scenarios includes adjusting values of a forecast using historic data so as to incorporate an assumption dependency structure into the forecast;
for each of the market scenarios, generating, by the energy risk management system, an expected performance value for an energy asset;
determining, by the energy risk management system, that the expected performance value has a predetermined characteristic for at least one of the market scenarios; and
in response to the determination, generating, by the energy risk management system, an output, the output including at least one of: an alert indicative of the predetermined characteristic, an energy asset suggestion, a power production command, and a visualization of a distribution of the generated expected performance value.

12. The method of claim 11, wherein the predetermined characteristic is that a range of the generated expected performance values is above a threshold to indicate a high market volatility.

13. The method of claim 12, wherein the output includes an alert for display via transmittal via the network interface.

14. The method of claim 11, wherein the predetermined characteristic is that the distribution of the generated expected performance values is above a threshold value.

15. The method of claim 14, wherein the output includes both the visualization of the distribution and an energy asset suggestion.

16. The method of claim 11, wherein the energy asset includes a power generator, wherein the output includes a power utilization command.

17. The method of claim 11, further comprising:
decomposing, by the energy risk management system, at least one of the generated expected performance values into energy price subcomponents; and
presenting, via the energy risk management system, the user with a visualization of the decomposed generated expected performance value.

18. The method of claim 17, further comprising:
receiving, by the energy risk management system, a set of risk preferences associated with the user;
determining, by the energy risk management system, that the distribution of expected performance values does not comport with the set of risk preferences;
in response to determining that the distribution of projected values does not comport with the set of risk preferences, identifying, by the energy risk management system, a risk counteracting transaction; and
presenting, by the risk energy management system the user with the risk counteracting transaction.

19. The method of claim 1, wherein the historical data is selected based on a desired dependency structure to incorporate into one of the market scenarios.

20. The method of claim 19, wherein the historical data includes energy prices from a previous year.
